(19) United States
(12) Patent Application Publication
(10) Pub. No.: US 2026/0002041 A1
(43) Pub. Date: Jan. 1, 2026

(54) CONCENTRATED TITANIUM DIOXIDE SLURRY FOR USE FOR PAINTS AT THE POINT OF SALE

(71) Applicant: Harris Paints International Ltd., Castries (LC)

(72) Inventor: Charles Henderson Kirton, St. Philip (BB)

(21) Appl. No.: 18/880,700

(22) PCT Filed: Jul. 15, 2022
(86) PCT No.: PCT/IB2022/056549

§ 371 Date: Jan. 2, 2025

(51) Int. Cl. C09D 17/00; C09D 5/14; C09D 7/43; C09D 7/45; C09D 7/62; C09D 7/63

(52) U.S. Cl. CPC C09D 17/008; C09D 5/14; C09D 7/43; C09D 7/45; C09D 7/62; C09D 7/63; C09D 17/001

(57) ABSTRACT

The present invention relates to a titanium dioxide pigment composition for use in paint formulations, wherein the pigment composition comprises a plurality of titanium dioxide particles, and a dispersant package deposited on the surfaces of the titanium dioxide particles. The dispersant package includes water, at least one preservative, organic alkali salts, at least one thickener, at least one preservative, at least one defoamer, and at least one resin

### FIELD OF THE INVENTION

The instant application is related to the field of coatings, particularly paints, more specifically, the preparation of paints at the point of sale by adding pigments, particularly in the form of concentrated slurries.

### BACKGROUND OF THE INVENTION

Paints and coatings are used to protect a surface from corrosion, oxidation, or other types of deterioration and to provide decorative effects.

Organic solvent-based paint or coating is a uniformly dispersed mixture ranging in viscosity from a thin liquid to a semi-solid paste and includes a film-forming polymeric binder, an organic solvent, pigment and other additives. The binder and the solvent collectively make what is known as the “vehicle”. Latex or emulsion paint is a water-based paint or coating of a dispersion of dry powders of pigment and dispersed colorant, plus various paint additives such as fillers and extenders, and a resin dispersion.

Typically, a dispersion of the dry powder is made by milling the dry ingredients into water. The resin dispersion is either a latex formed by emulsion polymerization or a resin in emulsion form. The two dispersions are blended to form an emulsion, or latex, paint. Thus, the binder for latex paints and coatings is in an aqueous-dispersed form, whereas in a solvent paint or coating the binder is in a soluble form.

Latex paints and coatings are popular consumer paints, as they are easy to apply, are easy to clean up, are nonflammable, generally lack a disagreeable odor and can be used on both interior and exterior surfaces.

Pigments impart color to both solvent and latex paints and coatings. They also contribute to the opacity, durability, and hardness of paint coatings. They are added to paint in the form of dry pigment powders and pigmented tinting concentrate during paint manufacture at the paint plant. In addition, especially for consumer latex paints, they may be added in the form of pigmented paint tinting concentrates at the point of sale, such as at retail paint stores.

Essentially, the consumer may choose a custom-made color of the paint by having the retailer add a tinting concentrate to a white or tintable base. Pigments are ordinarily organic or inorganic dry powders consisting of a mixture of primary particles, aggregates, and agglomerates.

Aggregates are primary pigment particles joined face-to-face, and agglomerates are primary pigment particles joined at an edge or a corner. For both industrial and consumer paints, whether solvent or latex, pigment must be dispersed homogeneously throughout the paint when added. To properly be dispersed, pigments must be wetted, deaggregated and deagglomerated in the paint vehicle.

Dry pigments are insoluble in organic solvents and water, therefore necessitating wetting, deaggregation and deagglomeration before dispersion forces can take full effect and enable the production of a stable, colloidal pigmentary dispersion in the paint vehicle. The wetting or deaeration process is physical in nature, as it requires that the vehicle or solvent displace the air on the surface of the pigment particles.

The ideal dispersion consists of a homogenous suspension of primary particles, after reducing any aggregates and agglomerates to primary particles. The wetting process is accomplished through the use of wetting agents, which are a type of surface-active agent or “surfactant.”

Titanium dioxide (TiO₂) is produced commercially in two crystalline polymorphic forms, namely the rutile form which can be produced by both the chloride and sulfate processes and the anatase form which is produced by the sulfate process.

After dry or wet grinding of TiO₂ pigment to a desired pigmentary particle size, the pigment may be shipped to end users as either a dry powder or an aqueous slurry. The shipment of high solids aqueous slurries has certain advantages to end-users because they do not have to undertake the rather complex and time-consuming process of mixing titanium dioxide pigments and water for use in making paper, coatings, paint, or other products. However, it also presents disadvantages in that the shipping of large amounts of water over large distances is an inefficient use of resources. Another disadvantage is that the water present in lower solids slurries may create excess dilution in certain applications, requiring costly and time-consuming drying to remove the excess water.

Accordingly, the state of the art contains several disclosures directed to paints or slurries with the same objective, such as document US2019/0249014 which describes a composition of titanium dioxide pigment for use in water-based latex paint formulations. A titanium dioxide pigment slurry composition is also provided, a method to form a titanium dioxide pigment composition, and a method to form a titanium dioxide pigment slurry composition, all to be employed in water-based latex formulations. The composition comprises a dispersant package that includes a) a neutralizing agent selected from the group comprising organic compounds that have at least one amino functional group; b) a selected dispersant component of low molecular weight monomeric dispersants, polymeric dispersants, and combinations thereof; and c) at least one component of hydronic alcohol.

According to the above, it can be seen that this document can be considered as a general state of the art for the present invention, since it specifically mentions a slurry of titanium dioxide that can be added to latex paint bases, a method of producing such slurry that includes grinding titanium dioxide with water and the other ingredients, and a dispersing package that includes some of the ingredients present in the composition of the invention.

Similarly, document U.S. Pat. No. 5,622,628 discloses a novel method for the production of titanium dioxide slurries that have a high solids content, which involves subjecting a titanium dioxide slurry to crossflow filtration to produce a slurry containing at least 50%, preferably 60 to 80% titanium dioxide by weight. It also describes that titanium dioxide undergoes a wet grinding process.

Now, document U.S. Pat. No. 4,288,254 describes a process for preparing a titanium dioxide slurry that has a solids content of at least 60%. The process involves the steps of mixing the titanium dioxide pigment, at least one additive or dispersant and water to a first mixture that has a solids content of at least 60%, pumping the first mixture through a mill to produce a second mixture free of agglomerates.

According to the above, it can be seen that this document discloses the formation of a titanium dioxide slurry comprising a grinding stage with additives selected from dispersing additives, biocides, agents that prevent sedimentation, caustic agents to adjust the pH and anti-foaming agents.

On the other hand, document US2002091192 teaches a titanium dioxide slurry made directly from an unfinished pigment of titanium dioxide produced from the chloride or sulfate process. The process comprises a grinding stage of a mixture of titanium dioxide and water comprising a dispersant and an organic amine.

Thus, it can be seen that this document, like the other previous ones, is considered as a general state of the art for the present invention, since it mentions the manufacture of a titanium dioxide slurry comprising a grinding stage, and the presence of dispersants.

From the above, it can be concluded that the state of the art contains a series of documents related to methods or processes to produce titanium dioxide slurries to be used as additives in paint bases based on latex and water. However, these documents constitute general references to the state of the art, and none fully anticipates the invention developed, both in its components and in the quantities thereof. Therefore, a developed invention is novel in light of the documents identified, but some of them may affect the inventive level of the application, depending on how a patent examiner interprets them.

Likewise, it is important to highlight the fact that all state-of-the-art documents mention in a generic way the presence of additives that can be considered commonly used in the industry. Therefore, the inventive level of the technology should focus on the particular properties that the included additives confer on the developed slurry, emphasizing the reasons why the same were selected in particular over others commonly available in trade, as well as the quantities of each of them.

### DESCRIPTION OF THE INVENTION

In one aspect, a concentrated titanium dioxide slurry composition for use in paint formulations is provided. The composition comprises a plurality of titanium dioxide particles, and a dispersant package deposited on the surfaces of the titanium dioxide particles. The dispersant package includes water, at least one preservative, organic alkali salts, at least one thickener, at least one defoamer, and at least one resin.

The recitation of a numerical range using endpoints includes all numbers subsumed within that range (e.g., 1 to 5 includes 1, 1.5, 2, 2.75, 3, 3.80, 4, 5, etc.).

The terms “a,” “an,” “the,” “at least one,” and “one or more” are used interchangeably. Thus, for example, a coating composition that contains “an” additive means that the coating composition includes “one or more” additives.

The term “binder” means a film-forming natural or synthetic polymer suitable for use in paints and other coating composition.

The term “circulating” when used with respect to a composition means that the composition is a fluid that may or may not contain dispersed solid particles and which is undergoing stirring, agitation, or other shear forces sufficient to mix components in the composition.

The term “fluid” when used in reference to a substance means that the substance is a liquid that may or may not contain dispersed solid particles and which has a loss modulus (G″) greater than its storage modulus (G′) and a loss tangent (tan δ) greater than 1.

The term “low VOC” when used with respect to paints and other coating composition means that the coating composition contains less than about 5 wt. percent volatile organic compounds, preferably less than about 3 wt. % volatile organic compounds, more preferably less than about 1 wt. % volatile organic compounds and most preferably less than about 0.5 wt. % volatile organic compounds based upon the total coating composition weight.

The term “pigment” means an inorganic particulate material having light-reflective characteristics and a surface energy and particle size suitable for use in paints and other coating compositions.

The terms “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful and is not intended to exclude other embodiments from the scope of the invention.

The term “solvent-borne” when used with respect to paints or other coating compositions means that the major liquid vehicle or carrier for such coating composition is a nonaqueous solvent or mixture of nonaqueous solvents.

When used with respect to a component which may be found in a paint or other coating composition, the term “substantially free of” means containing less than about 1 weight percent of the component based on the coating composition weight.

The term “water-borne” when used with respect to paints and other coating compositions means that the major liquid vehicle or carrier for such coating composition is water.

The slurry according to the instant application comprises about 60 wt. % to about 80 wt. % titanium dioxide particles, wherein the titanium dioxide is produced by highly dispersing a selected grade of rutile titanium dioxide to a Hegman grind 7.5 N.S. in a water-based medium.

The disclosed titanium dioxide particles provide light scattering sites within a dried film of the disclosed coating compositions and impart hiding or opacity to the dried film. The titanium dioxide particles may have a variety of shapes and sizes but desirably will scatter photons having wavelengths in the spectral region from 300 nm to 750 nm and especially in the visible spectral region from 380 nm to 700 nm. Suitable shapes for the titanium dioxide particles include spherical shapes, such as a regular sphere, an oblate sphere, a prolate sphere, and an irregular sphere; cubic shapes such as a regular cube and a rhombus; plate-like shapes including a flat plate, a concave plate, and a convex plate; and irregular shapes. Particles having spherical shapes desirably have average diameters of about 10 nm to about 1,000 nm, e.g., about 100 nm to about 500 nm, about 200 nm to about 300 nm, or about 230 nm. Particles having non-spherical shapes desirably have a maximum diameter of up to about 1 micrometer, e.g., up to about 500 nm or up to about 300 nm. The titanium dioxide particles may include one or more coatings, e.g., of silica, alumina, zirconia or combinations thereof such as a silica coating and an alumina coating.

The disclosed compositions contain (and the disclosed methods may employ) water, which may be tap, deionized, distilled, reverse osmosis or recycled water. Preferably the pigment grind dispersion contains sufficient water to facilitate efficient pigment grind mixing (e.g., about 9 to about 30 weight percent water based on the weight of ingredients in the pigment grind dispersion).

The ingredient amounts in the disclosed pigment grind dispersions will to some extent depend upon the other ingredients present.

The disclosed method and composition can provide improved storage stability (for example, avoidance of undesirable changes in viscosity, such as rapid viscosity increases), reduced grit (viz., solid particle) formation, or both improved storage stability and reduced grit formation compared to pigment grind dispersions prepared using previously recommended methods. Improved storage stability, reduced grit formation or both improved storage stability and reduced grit formation are useful for a variety of reasons including facilitating inventory management, process control and process improvement in large-scale mixing of paints and other coating compositions.

The disclosed concentrated titanium dioxide slurry compositions may include optional ingredients that assist with or do not unduly interfere with pigment dispersion, such as extender particles, dispersing agents, defoamers, wetting agents and mixtures thereof.

Exemplary defoamers include silicones, ethylene oxide propylene oxide copolymers, oils and waxes such as FOAMSTAR A-32, FOAMSTAR A-34, FOAMSTAR A-36, FOAMSTAR A-38, FOAMSTAR A-39, FOAMASTER 111, FOAMASTER 333 and FOAMASTER SA-3 from Cognis, TEGO FOAMEX 810 from Evonik, mixtures thereof and other materials that will be familiar to persons having ordinary skill in the art, including products from other suppliers such as Air Products and Chemicals, Ashland, BASF, BYK-Gardner USA, Cytec, Rhone Poulenc and Troy Corporation. The defoamers may be present in an amount between about 0.5% and about 1%, based on the total weight of the composition.

Exemplary extender particles include calcium carbonate, calcium sulfate, barium sulfate, mica, clay, calcined clay, feldspar, nepheline, syenite, wollastonite, diatomaceous earth, alumina silicates, non-film forming polymer particles, aluminum oxide, silica, talc, mixtures thereof and other materials that will be familiar to persons having ordinary skill in the art.

Exemplary dispersing agents include anionic polyelectrolyte dispersants such as maleic acid copolymers, acrylic acid copolymers including methacrylic acid copolymers, and carboxylic acids such as tartaric acid, succinic acid, citric acid, itaconic acid, mixtures thereof and other materials that will be familiar to persons having ordinary skill in the art.

Other ingredients included in the concentrated titanium dioxide slurry compositions include cosolvents, wetting agents, surfactants, biocides, and/or pH regulators.

Exemplary thickeners and other theology modifiers include sedimentation inhibitors, hydrophobic ethoxylated urethane resin (HEUR) thickeners, hydrophobically-modified, alkali-soluble or alkali-swellable emulsion (HASE) thickeners), modified cellulosic thickeners, polysaccharide resin thickeners, attapulgite clay thickeners and mixtures thereof. Exemplary commercially-available rheology modifiers include NATROSOL 250 and the AQUAFLOW series from Ashland, ATTAGEL 50 from BASF Corp., the CELLOSIZE series and UCAR POLYPHOBE™ T-900 and T-901 from Dow Chemical Co., BENTONE AD and BENTONE EW from Elementis Specialties, LATTICE NTC-61 from FMC Biopolymer and ACRYSOL™ RM-6, ACRYSOL RM-8, ACRYSOL RM-12W and ACRYSOL RM-2020NPR all from Rohm & Haas. When a rheology modifier is present, the coating compositions preferably contain about 0.1 to about 3 or about 0.5 to about 3 weight percent rheology modifier based on the final coating composition weight.

The compositions may also contain a variety of other adjuvants that will be familiar to persons having ordinary skill in the art. Representative adjuvants are described in Koleske et al., Paint and Coatings Industry, April 2003, pages 12-86. Exemplary adjuvants and commercial examples of the same include biocides, fungicides, mildewcides and preservatives (e.g., BUSAN 1292 from Buckman Laboratories, Inc., NOPCOCIDE N-40D from Cognis, KATHON LX from Rohm & Haas, and POLYPHASE 663, POLYPHASE 678 and POLYPHASE PW-40 from Troy Corporation, 1,2-benzisothiazol-3(2H)-one, 5-chloro-2-methyl-4-isothiazolin-3-one and 2-methyl-2H-isothiazol-3-one); curing indicators; heat stabilizers; leveling agents; light stabilizers (e.g., hindered amine light stabilizers such as TINUVIN 123-DW and TINUVIN 292 HP from Ciba Specialty Chemicals); optical brighteners; ultraviolet light absorbers (e.g., TINUVIN 234 and TINUVIN 1130 from Ciba Specialty Chemicals); wetting agents (e.g., BYK™ 346 and BYK 348 from Altana, PENTEX 99 from Rhodia and TROYSOL LAC from Troy corporation); waxes (e.g., AQUACER 593 from Altana, HYDROCER 303 from Shamrock Technologies, Inc. and MICHEM Emulsion 32535 from Michelman, Inc.); and the like. The types and amounts of these and other adjuvants typically will be empirically selected.

The surface-treated titanium dioxide pigment according to the present application is an active coloring agent that is suspended in aqueous medium with the support of a rheological matrix provided by a balanced combination of modified cellulosic thickener and attapulgite clay. The mixture is stabilized by the addition of a specially selected polycarboxylic acid sodium salt as a surfactant and an amine additive as a pH regulator. The functionality of the mixture is enhanced with a carefully balanced combination of glycol cosolvent and polysaccharide resin acting as humectants and flow agents.

More particularly, in a particularly preferred embodiment, the concentrated titanium dioxide slurry composition comprises between about 60 wt. % and about 80 wt. % rutile titanium dioxide pigment, about 9.0 to about 30 wt. % water, about 0.5 to about 1.0 wt. % wet state biocide preservative, about 0.5 wt. % to about 1.0 wt. % cellulosic thickener, about 0.5 wt. % to about 1.0 wt. % attapulgite clay thickener, about 2.0 wt. % to about 8.0 wt. % propylene glycol, about 1.0 wt. % to about 6.0 wt. % sodium salt of polycarboxylic acid, about 0.5 wt. % to about 1.0 wt. % silica base defoamer, about 0.5 wt. % to about 1.0 wt. % amine additive, about 1.0 wt. % to about 8.0 wt. % polysaccharide resin derivative.

The viscosity of the concentrated titanium dioxide slurry compositions according to the instant application may be between about 1000 cp and about 3000 cp at 25° C.

The concentrated titanium dioxide slurry compositions may be packaged in any convenient packaging suitable for storing a desired quantity of the coating composition without premature gelation, undue separation, or other undesirable degradation during storage. Exemplary packaging containers include cans, pails, bottles, drums, totes, and tanks. The disclosed compositions may be factory-applied to substrates such as building components at a manufacturing site or may be supplied to end users and applied onsite to finished articles, e.g., as paints for use on decks, siding, roofing, or other surfaces.

Having thus described preferred embodiments of the present invention, those of skill in the art will readily appreciate that the teachings found herein may be applied to yet other embodiments within the scope of the claims hereto attached. The complete disclosure of all patents, patent documents, and publications are incorporated herein by reference as if individually incorporated.

1-4. (canceled)

5. A titanium dioxide slurry composition comprising:
(a) a plurality of titanium dioxide particles present at a concentration ranging from about 60 wt. % to about 80 wt. %, by weight of the titanium dioxide slurry; and
(b) a dispersant package comprising:
(i) water;
(ii) a preservative;
(iii) a surfactant;
(iv) a thickener; and
(v) a defoamer.

6. The titanium dioxide slurry composition according to claim 5, wherein the titanium dioxide particles are present at a concentration from about 70 wt. % to about 80 wt. %, by weight of the titanium dioxide slurry.

7. The titanium dioxide slurry composition according to claim 5, wherein the titanium dioxide particles are coated with at least one of a silica, an alumina, and a zirconia.

8. The titanium dioxide slurry composition according to claim 5, wherein the water is present at a concentration ranting from about 9 wt. % to about 30 wt. %, by weight of the titanium dioxide slurry.

9. The titanium dioxide slurry composition according to claim 5, wherein at least one of:
the defoamer comprises at least one of a silica, an ethylene oxide propylene oxide copolymer, an oil, a wax, Foamstar A-32, Foamstar A-34, Foamstar A-36, Foamstar A-38, Foamstar A-39, Foamaster 111, Foamaster 333, Foamaster SA-3, Tego Foamex 810, and
the defoamer is present at a concentration ranging from about 0.1 wt. % to about 1 wt. %, by weight of the titanium dioxide slurry.

10. The titanium dioxide slurry composition according to claim 5, wherein the titanium dioxide particles are present at a concentration of at least about 70 wt. %, by weight of the titanium dioxide slurry.

11. The titanium dioxide slurry composition according to claim 5, wherein the dispersant package further comprises a dispersing agent comprising at least one of maleic acid copolymers, acrylic acid copolymers, methacrylic acid copolymers, tartaric acid, succinic acid, citric acid, itaconic acid.

12. The titanium dioxide slurry composition according to claim 5, wherein at least one of:
the thickener comprises hydrophobic ethoxylated urethane resin (HEUR) thickeners, hydrophobically-modified, a colloidal clay, alkali-soluble or alkali-swellable emulsion (HASE), modified cellulosic thickeners, polysaccharide resin thickeners, attapulgite clay thickeners and mixtures thereof, and
the thickener is present at a concentration ranging from about 0.1 wt. % to about 3 wt. %, by weight of the titanium dioxide slurry composition.

13. The titanium dioxide slurry composition according to claim 5, wherein at least one of:
the preservative is present at a concentration ranging from about 0.5 wt. % to about 1.0 wt. %, by weight of the titanium dioxide slurry composition, and
the preservative comprises at least one of 1,2-benzisothiazol-3(2H)-one, 5-chloro-2-methyl-4-isothiazolin-3-one and 2-methyl-2H-isothiazol-3-one.

14. The titanium dioxide slurry composition according to claim 5, wherein at least one of:
the surfactant comprises a sodium salt of polycarboxylic acid, and
the surfactant is present at a concentration ranging from about 1 wt. % to about 6 wt. %, by weight of the titanium dioxide slurry composition.

15. The titanium dioxide slurry composition according to claim 5, wherein the preservative comprises at least one of a biocide, a fungicide, and a mildewcide.

16. The titanium dioxide slurry composition according to claim 5, further comprising a propylene glycol at a concentration ranging from about 2 wt. % to about 8 wt. %, by weight of the titanium dioxide slurry.

17. The titanium dioxide slurry composition according to claim 5, further comprising a colloidal clay thickener at a concentration ranging from about 0.5 wt. % to about 1 wt. %, by weight of the titanium dioxide slurry.

18. The titanium dioxide slurry composition according to claim 5, an amine additive at a concentration ranging from about 0.5 wt. % to about 1.0 wt. %, by weight of the titanium dioxide slurry.

19. The titanium dioxide slurry composition according to claim 5, wherein at least one of:
the titanium dioxide slurry composition has a viscosity ranging from about 1,000 cp to about 3,000 cp at a temperature of about 25°, and
titanium dioxide particles are produced by highly dispersing a selected grade of rutile titanium dioxide to a Hegman grind 7.5 N.S. in a water-based medium.
